(19) United States
(12) Patent Application Publication
(10) Pub. No.: US 2023/0069874 A1
(43) Pub. Date: Mar. 9, 2023

(54) MALE TERMINAL FITTING AND TERMINAL STRUCTURE

(71) Applicant: SUMITOMO WIRING SYSTEMS, LTD., Mie (JP)

(72) Inventor: Kentaro HIRAI, Mie (JP)

(21) Appl. No.: 17/798,263

(22) PCT Filed: Jan. 22, 2021
(86) PCT No.: PCT/JP2021/002125

§ 371 Date: Aug. 8, 2022

(30) Foreign Application Priority Data
Feb. 10, 2020 (JP) 2020-020286

(51) Int. Cl. H01R 13/04

(52) U.S. Cl. CPC H01R 13/04

(57) ABSTRACT

A male terminal fitting (10) is provided with a solid tab (11) extending in an axial direction. The tab (11) has one surface (15) to be contacted by a contact point portion (63) of a female terminal fitting (60) and a pair of side surfaces (17) intersecting and connected to both ends in a width direction of the one surface (15). The one surface (15) of the tab (11) includes a pair of recesses (18) located on both end sides in the width direction and open in the pair of side surfaces (17) in a sliding range of the contact point portion (63) in the axial direction. A width between the pair of recesses (18) on the one surface (15) of the tab (11) is smaller than a maximum width of the contact point portion (63).

### TECHNICAL FIELD

The present disclosure relates to a male terminal fitting and a terminal structure.

### BACKGROUND

Patent Document 1 discloses a male terminal and a female terminal to be connected to each other. The male terminal includes a tab terminal portion. The tab terminal portion is inserted into a tubular portion of the female terminal. The tab terminal portion includes a contacted portion to be brought into contact with a spring contact portion in the tubular portion when the male terminal and the female terminal are connected, and a recess provided around the contacted portion. The recess is provided by recessing a central part of the tab terminal portion.

In the case of Patent Document 1, if vibration is applied and oxidized abrasion powder is produced due to fine sliding abrasion between the contacted portion of the tab terminal portion and the spring contact portion with the male terminal and the female terminal connected, the produced oxidized abrasion powder can enter the recess. Further, a technique for specifying the hardness of plating applied to a connected part of a male terminal and a female terminal is disclosed in Patent Document 2.

### PRIOR ART DOCUMENT

### Patent Document

Patent Document 1: JP 2016-039104 A

Patent Document 2: JP 2011-113636 A

### SUMMARY OF THE INVENTION

### Problems to be Solved

In Patent Document 1, if vibration is further applied with the oxidized abrasion powder accumulated in the recess, the oxidized abrasion powder may jump up to be present between contact points of the tab terminal portion and the spring contact portion and the connection reliability of the male terminal and the female terminal may be reduced.

Accordingly, the present disclosure aims to provide a male terminal fitting and a terminal structure with improved connection reliability.

### Means to Solve the Problem

The present disclosure is directed to a male terminal fitting with a solid tab extending in an axial direction, wherein the tab has one surface to be contacted by a contact point portion of a female terminal fitting and a pair of side surfaces intersecting and connected to both ends in a width direction of the one surface, and the one surface of the tab includes a pair of recesses located on both end sides in the width direction and open in the pair of side surfaces in a sliding range of the contact point portion in the axial direction.

The present disclosure is directed to a terminal structure with a male terminal fitting and a female terminal fitting to be connected to each other, wherein the female terminal fitting includes a deflectable and deformable resilient piece and a contact point portion projecting on the resilient piece, the male terminal fitting includes a solid tab extending in an axial direction, the tab has one surface to be contacted by the contact point portion and a pair of side surfaces intersecting and connected to both ends in a width direction of the one surface, the one surface of the tab includes a pair of recesses located on both end sides in the width direction and open in the pair of side surfaces in a sliding range of the contact point portion in the axial direction, and a width between the pair of recesses on the one surface of the tab is smaller than a maximum width of the contact point portion.

### Effect of the Invention

According to the present disclosure, it is possible to provide a male terminal fitting and a terminal structure with improved connection reliability.

### BRIEF DESCRIPTION OF THE DRAWINGS

FIG. 1 is a plan view of a male terminal fitting of a first embodiment.

FIG. 2 is a section along A-A of FIG. 1.

FIG. 3 is a front view of the male terminal fitting.

FIG. 4 is a side view with the male terminal fitting shown in section in a state where the male terminal fitting and a female terminal fitting are properly connected.

FIG. 5 is a plan view of a male terminal fitting of a second embodiment.

FIG. 6 is a view, corresponding to FIG. 2.

### DETAILED DESCRIPTION TO EXECUTE THE INVENTION

### Description of Embodiments of Present Disclosure

First, embodiments of the present disclosure are listed and described.

(1) The male terminal fitting of the present disclosure is provided with a solid tab extending in an axial direction, wherein the tab has one surface to be contacted by a contact point portion of a female terminal fitting and a pair of side surfaces intersecting and connected to both ends in a width direction of the one surface, and the one surface of the tab includes a pair of recesses located on both end sides in the width direction and open in the pair of side surfaces in a sliding range of the contact point portion in the axial direction.

According to this configuration, even if the contact point portion slides in the sliding range of the one surface of the tab and plating on the one surface of the tab is peeled off in the process of connecting the male terminal fitting to the female terminal fitting, abrasion powder of the peeled-off plating can be removed to outside from side-surface openings of the pair of recesses. Thus, the presence of the abrasion powder between the one surface of the tab and the contact point portion of the female terminal fitting can be prevented and connection reliability can be improved.

(2) Preferably, the one surface of the tab includes a middle recess in the sliding range of the contact point portion in the axial direction and between the pair of recesses in the width direction. According to this configuration, the abrasion powder of the peeled-off plating can be divided into a part to be removed from the pair of recesses and a part staying in the middle recess. As a result, a removed amount and an accumulated amount of the abrasion powder can be adjusted.

(3) The pair of recesses may have slopes inclined downward toward the pair of side surfaces. According to this configuration, the abrasion powder of the peeled-off plating can be made to fall along the slopes of the pair of recesses and quickly removed from the side-surface openings.

(1) Further, the terminal structure of the present disclosure is provided with a male terminal fitting and a female terminal fitting to be connected to each other, wherein the female terminal fitting includes a deflectable and deformable resilient piece and a contact point portion projecting on the resilient piece, the male terminal fitting includes a solid tab extending in an axial direction, the tab has one surface to be contacted by the contact point portion and a pair of side surfaces intersecting and connected to both ends in a width direction of the one surface, the one surface of the tab includes a pair of recesses located on both end sides in the width direction and open in the pair of side surfaces in a sliding range of the contact point portion in the axial direction, and a width between the pair of recesses on the one surface of the tab is smaller than a maximum width of the contact point portion.

According to this configuration, even if the contact point portion slides in the sliding range of the one surface of the tab and plating on the one surface of the tab is peeled off in the process of connecting the male terminal fitting to the female terminal fitting, abrasion powder of the peeled-off plating can be removed to outside from side-surface openings of the pair of recesses. Further, since the width between the pair of recesses on the one surface of the tab is smaller than the maximum width of the contact point portion, the abrasion powder of the peeled-off plating can be quickly moved to the pair of recesses. As a result, the presence of the abrasion powder between the one surface of the tab and the contact point portion of the female terminal fitting can be more reliably prevented.

### Details of Embodiment of Present Disclosure

Specific examples of the present disclosure are described below with reference to the drawings. Note that the present invention is not limited to these illustrations and is intended to be represented by claims and include all changes in the scope of claims and in the meaning and scope of equivalents.

### First Embodiment

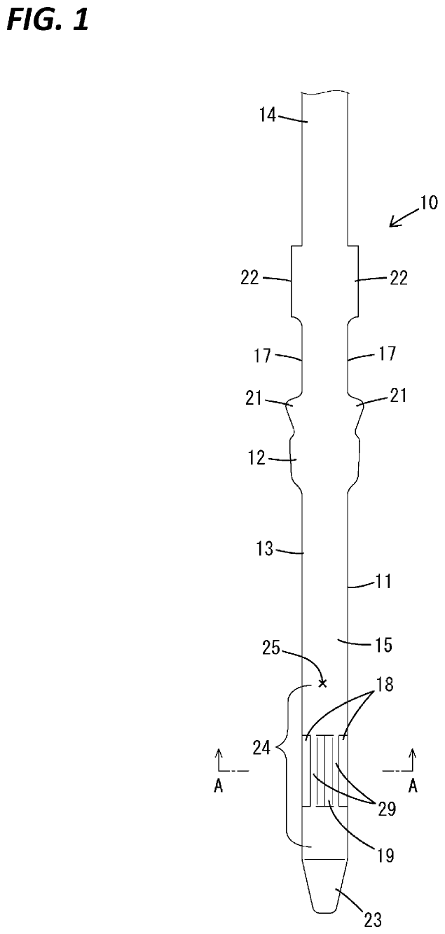

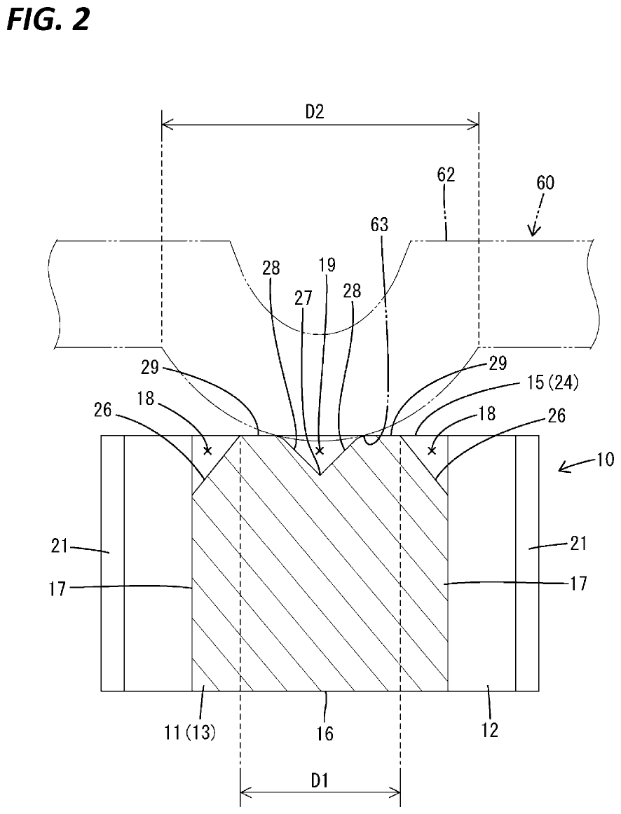

A first embodiment is provided with a male terminal fitting 10 and a female terminal fitting 60 connectable to each other. Note that, in the following description, a height direction is a vertical direction of FIGS. 2 to 4 and a width direction is a lateral direction of FIGS. 1 to 3. An axial direction is a vertical direction of FIG. 1, a front-rear direction of FIG. 4 and a length direction of a tab 11 to be described later. Further, sides facing each other when the male terminal fitting 10 and the female terminal fitting 60 are connected are referred to as front sides concerning a front-rear direction.

The female terminal fitting 60 is formed by bending an electrically conductive metal plate. As shown in FIG. 4, the female terminal fitting 60 includes a tubular connecting portion 61. The female terminal fitting 60 is connected to an end part of an unillustrated wire behind the connecting portion 61. The connecting portion 61 includes a resilient piece 62 extending rearward from the front wall of an upper wall (wall on an upper side in FIG. 4) inside this connecting portion 61. The resilient piece 62 is vertically deflectable and deformable with a front end side of the upper wall as a fulcrum. The resilient piece 62 includes an embossed (hemispherical) contact portion 63 curved downward at an intermediate position in an extending direction. The connecting portion 61 includes a receiving portion 64 at a position facing the resilient piece 62 in an inner wall part of a lower wall (wall on a lower side in FIG. 4). The receiving portion 64 is bent in the inner wall part of the lower wall and has a flat upper surface along the front-rear direction. The connecting portion 61 includes a locking projection 65 bent outward in an outer wall part of the lower wall. The locking projection 65 is locked to an inner wall of a cavity of an unillustrated female housing. The female terminal fitting 60 is retained in the female housing by locking the locking projection 65 to the inner wall of the cavity.

The male terminal fitting 10 includes the tab 11 extending long in the front-rear direction (vertical direction of FIG. 1, axial direction). The tab 11 is a solid member having no space inside, and formed by stamping the metal plate by press working. Plating such as tin (Sn) plating is applied to the surface of the male terminal fitting 10 including the tab 11.

The tab 11 is mounted through a back wall of a receptacle of an unillustrated board connector. The board connector is installed on an unillustrated circuit board. As shown in FIG. 1, the tab 11 of the male terminal fitting 10 includes a fixing portion 12 to be fixed to the back wall of the receptacle, a terminal connecting portion 13 projecting forward (downward in FIG. 1) from the fixing portion 12 and to be arranged in the receptacle, and a board connecting portion 14 projecting rearward (upward in FIG. 1) from the fixing portion 12 and to be soldered and connected to an electrically conductive path of the circuit board. Note that the board connecting portion 14 is not shown in detail in FIG. 1.

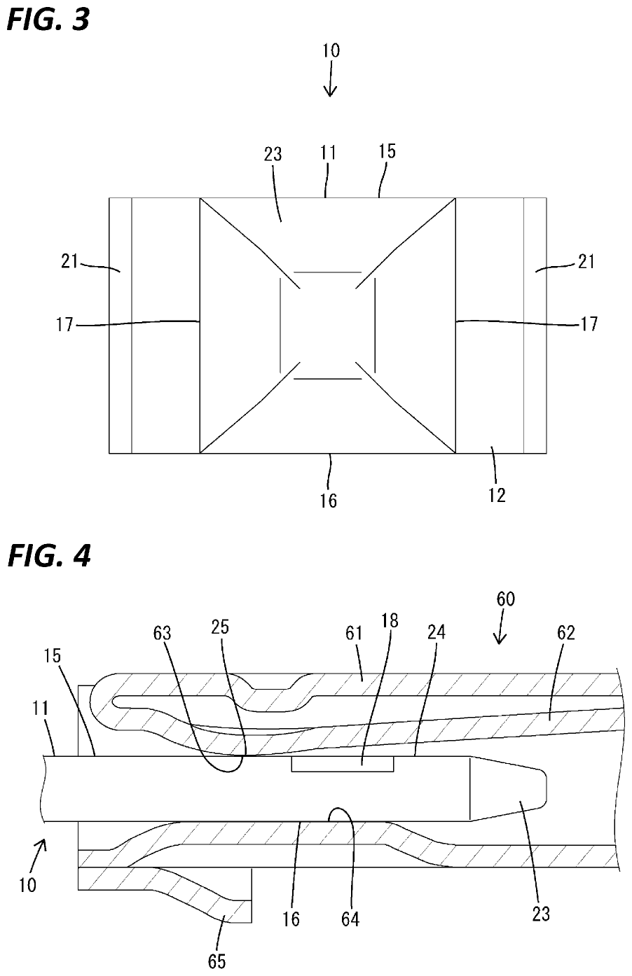

The tab 11 has a rectangular transverse cross-sectional shape and has, as shown in FIG. 3, one surface 15 and another surface 16 paired in the height direction (vertical direction of FIG. 3) and a pair of side surfaces 17 paired in the width direction (lateral direction of FIG. 3). As shown in FIG. 2, the one surface 15 includes a pair of recesses 18 and a middle recess 19, and the other surface 16 includes neither the both recesses 18 nor the middle recess 19.

As shown in FIG. 2, the one and the other surfaces 15, 16 are flat surfaces along the width direction (except the pair of recesses 18 and the middle recess 19 in the one surface 15), and arranged parallel to each other in the height direction. The both side surfaces 17 are upright surfaces in the height direction and arranged in parallel in the width direction. A height of the both side surfaces 17 (also a height of the tab 11) is larger than a distance in the height direction between the contact point portion 63 of the resilient piece 62 before being deflected and deformed and the receiving portion 64.

As shown in FIG. 1, the fixing portion 12 includes a pair of locking portions 21 protruding laterally from the both side surfaces 17. The both locking portions 21 are in the form of claws in a plan view and bite into and are locked to the back wall of the receptacle. The fixing portion 12 includes a pair of stopper portions 22 protruding laterally from the both side surfaces 17 behind the both locking portions 22. The both stopper portions 22 have a rectangular shape in a plan view and are stopped in contact with the back wall of the receptacle. By stopping the both stopper portions 22 in contact with the back wall of the receptacle, an inserting operation of the male terminal fitting 19 into the receptacle is stopped.

The terminal connecting portion 13 includes a guiding portion 23 tapered toward a tip. As shown in FIG. 1, the terminal connecting portion 13 includes a sliding region 24 long in the axial direction (front-rear direction) between the guiding portion 23 and the fixing portion 12 on the one surface 15.

The sliding region 24 is formed in a sliding range from a start end position where the contact point portion 63 of the female terminal fitting 60 starts contacting to a final end position where the contacting is completed in a connection process of the male terminal fitting 10 and the female terminal fitting 60 on the one surface 15 of the terminal connecting portion 13. The terminal connecting portion 13 has a connection region 25 between the guiding portion 23 and the fixing portion 12 on the one surface 15 and at the final end position behind the sliding region 24. The connection region 25 is a contact point region contacted by the contact point portion 63 of the female terminal fitting 60 when the connection of the male terminal fitting 10 and the female terminal fitting 60 is completed (at the time of proper connection). The sliding region 24 and the connection region 25 are continuous without any step.

As shown in FIG. 2, the terminal connecting portion 13 includes the pair of recesses 18 on both widthwise end sides of the sliding region 24. The both recesses 18 are open in the one surface 15 and the both side surfaces 17 of the terminal connecting portion 13. The both recesses 18 have a pair of slopes 26 inclined downward from the one surface 15 toward the both side surfaces 17. The lower ends of the both slopes 26 are located above centers in the height direction of the both side surfaces 17 of the terminal connecting portion 13. The upper ends of the both slopes 26 are located closer to both end sides than a widthwise center on the one surface 15 of the terminal connecting portion 13.

The terminal connecting portion 13 includes the middle recess 19 on a widthwise central side of the sliding region 24. The middle recess 19 is open in the one surface 15 of the terminal connecting portion 13. The middle recess 19 has a bottom point portion 27 located in a widthwise center of the terminal connecting portion 13 (also a widthwise center of the tab 11) and a pair of inclined surfaces 28 inclined to expand toward both widthwise sides from the bottom point portion 27. The bottom point portion 27 is located above the lower ends of the both slopes 26 in the height direction of the tab 11.

The terminal connecting portion 13 has a pair of flat sliding surfaces 29 along the width direction between the both recesses 18 and the middle recess 19 in the sliding region 24 in the width direction.

The both recesses 18 and the middle recess 19 are arranged side by side across the both sliding surfaces 29 in the width direction. As shown in FIG. 1, the both recesses 18, the middle recess 19 and the both sliding surfaces 29 are formed in a certain range in the axial direction of the sliding region 24.

Front and rear surfaces of the both recesses 18 and those of the middle recess 19 are arranged along the height direction (see FIG. 4 only for the recess 18). Further, out of the terminal connecting portion 13, front and rear regions in front of and behind a region over the certain range in the axial direction formed with the both recesses 18, the middle recess 19 and the both sliding surfaces 29 are such that the one and the other surfaces 15, 16 flat along the width direction and the both side surfaces 17 upright in the height direction are connected orthogonally on four corners (see FIG. 3 for the front region).

Next, an operation process of connecting the male terminal fitting 10 and the female terminal fitting 60 is described.

In connecting the female housing into the receptacle of the board connector, the tab 11 of the male terminal fitting 10 arranged in the receptacle is inserted into the connecting portion 61 of the female terminal fitting 60. At this time, the receiving portion 64 slides on the other surface 16 of the tab 11 and the contact point portion 63 of the resilient piece 62 slides in the sliding region 24 of the one surface 15 of the tab 11 (see FIG. 4 for a connection completed state). The resilient piece 62 is deflected and deformed by being pressed by the tab 11. The tab 11 is sandwich in the height direction between the contact point portion 63 of the resilient piece 62 and the receiving portion 64.

As the contact point portion 63 approaches the connection region 25 of the tab 11, a contact load applied to the tab 11 from the resilient piece 62 gradually increases. In a final stage of the connection process where the contact load increases, the contact point portion 63 of the resilient piece 62 is in contact with the both sliding surfaces 29 as shown in FIG. 2. Specifically, the contact point portion 63 of the resilient piece 62 contacts end edge parts on both left and right sides across the middle recess 19 on the both sliding surfaces 29 of the sliding region 24. Note that a width (D1 shown in FIG. 2) between the pair of recesses 18 in the sliding region 24 is smaller than a maximum width (width of a base end side of a part projecting from the resilient piece 62; D2 shown in FIG. 2) of the contact point portion 63.

In the final stage of the connection process of the male terminal fitting 10 and the female terminal fitting 60, the plating formed in the sliding region 24 of the tab 11 may be scraped and peeled off by the contact point portion 63 of the resilient piece 62. However, in the case of the first embodiment, even if the plating is peeled off, a part of abrasion powder of the peeled-off plating enters the middle recess 19 on the widthwise central side of the sliding region 24, and another part enters the both recesses 18 on the both widthwise end sides of the sliding region 24, falls along the both slopes 26 and can be removed. Even if the abrasion powder having entered the middle recess 19 should come out from the middle recess 19, the coming-out abrasion powder quickly moves to the both widthwise end sides from the both inclined surfaces 28 according to a further sliding displacement of the contact point portion 63 and, similarly to the above, falls down from the both recesses 18 and can be removed.

Thus, according to the first embodiment, when the female housing is properly fit into the receptacle and the contact point portion 63 reaches the connection region 25 to complete the connection, the presence of the abrasion powder between the contact point portion 63 and the connection region 25 can be effectively prevented. As a result, a state where the contact point portion 63 and the connection region 25 are stably connected can be ensured and the connection reliability of the male terminal fitting 10 and the female terminal fitting 60 can be improved.

Particularly, in the case of the first embodiment, the abrasion powder of the peeled-off plating can be divided into the part to be removed from the both recesses 18 and the part staying in the middle recess 19. Thus, a removed amount and an accumulated amount of the abrasion powder can be adjusted. Further, since the both recesses 18 have the pair of slopes 26 inclined downward toward the both side surfaces 17, the abrasion powder of the peeled-off plating can be quickly removed, using the slops 26.

Further, since the width (D1 shown in FIG. 2) between the both recesses 18 in the sliding region 24 of the one surface 15 of the tab 11 is smaller than the maximum width (D2 shown in FIG. 2) of the contact point portion 63, the abrasion powder of the peeled-off plating can be quickly moved to the both recesses 18. As a result, the presence of the abrasion powder between the connection region 25 of the tab 11 and the contact point portion 63 of the female terminal fitting 60 can be effectively prevented.

### Second Embodiment

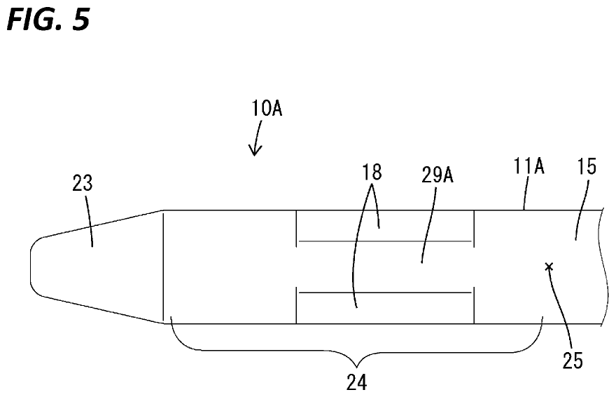

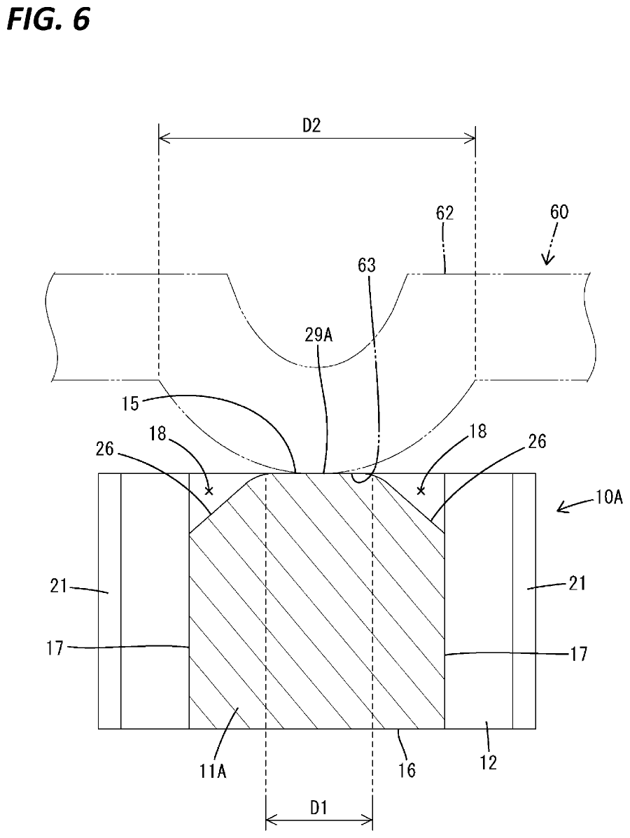

FIGS. 5 and 6 show an essential part of a male terminal fitting 10A of a second embodiment.

A pair of recesses 18 open in both side surfaces 17 are provided on both widthwise end sides of a sliding region 24 on one surface 15 of a tab 11A. The both recesses 18 have slopes 26 inclined downward toward the both side surfaces 17 and are formed as in the first embodiment.

However, a part corresponding to the middle recess 19 of the first embodiment is not provided on a widthwise central side of the sliding region 24 on the one surface 15 of the tab 11A. This point is different from the first embodiment.

A sliding surface 29A flat along the width direction is provided at a position including a widthwise central part of the tab 11A in a region between the pair of recesses 18 on the one surface 15 of the tab 11A. A width of the sliding surface 29A is a width between the pair of recesses 18 (D1 shown in FIG. 6) and smaller than a maximum width (D2 shown in FIG. 6) of a contact point portion 63 as in the first embodiment.

In a connection process of the male terminal fitting 10A and a female terminal fitting 60, the contact point portion 63 of a resilient piece 62 can slide in point or line contact with the sliding surface 29A of the tab 11A. At this time, even if plating on the sliding surface 29A is scraped and peeled off, abrasion powder of the peeled-off plating enters the both recesses 18, falls from the both slopes 26 and can be removed. Thus, also in the second embodiment, the presence of the abrasion powder between a connection region 25 of the tab 11A and the contact point portion 63 can be prevented and the connection reliability of the male terminal fitting 10A and the female terminal fitting 60 can be improved.

### Other Embodiments of Present Disclosure

The embodiments disclosed this time should be considered illustrative in all aspects, rather than restrictive.

Although the pair of recesses have the slopes in the case of the first and second embodiments, the pair of recesses may not have the slopes and may have, for example, surfaces along the height direction and surfaces along the width direction as another embodiment.

Although the middle recess has the both inclined surfaces in the case of the first embodiment, the middle recess may not have the both inclined surfaces and may be, for example, recessed to have a U-shaped (including a rectangular U shape) cross-section as another embodiment.

Although the middle recess is provided in the widthwise central part of the tab in the case of the first embodiment, the middle recess may be shifted toward one side from the widthwise central part of the tab as another embodiment.

Although the male terminal fitting is a terminal fitting for board connection to be connected to the circuit board in the case of the first embodiment, the male terminal fitting may be a terminal fitting for wire to be connected to a wire as another embodiment.

Although the slopes are formed straight in the length direction in the case of the first and second embodiments, the slopes may be, for example, curved or bent in the length direction as another embodiment.

Although the inclined surfaces are formed straight in the length direction in the case of the first embodiment, the inclined surfaces may be, for example, curved or bent in the length direction as another embodiment.

### LIST OF REFERENCE NUMERALS

10, 10A . . . male terminal fitting
11, 11A . . . tab
12 . . . fixing portion
13 . . . terminal connecting portion
14 . . . board connecting portion
15 . . . one surface
16 . . . other surface
17 . . . side surface
18 . . . recess
19 . . . middle recess
21 . . . locking portion
22 . . . stopper portion
23 . . . guiding portion
24 . . . sliding region
25 . . . connection region
26 . . . slope
27 . . . bottom point portion
28 . . . inclined surface
29, 29A . . . sliding surface
60 . . . female terminal fitting
61 . . . connecting portion
62 . . . resilient piece
63 . . . contact point portion
64 . . . receiving portion
65 . . . locking projection

1. A male terminal fitting, comprising a solid tab extending in an axial direction, wherein:
the tab has one surface to be contacted by a contact point portion of a female terminal fitting and a pair of side surfaces intersecting and connected to both ends in a width direction of the one surface,
the one surface of the tab includes a pair of recesses located on both end sides in the width direction and open in the pair of side surfaces in a sliding range of the contact point portion in the axial direction,
the one surface of the tab further includes a connection region, the connection region being a contact point region to be contacted by the contact point portion of the female terminal fitting when connection of the male terminal fitting and the female terminal fitting is completed, and
the connection region is located behind the recesses.

2. The male terminal fitting of claim 1, wherein:
the one surface of the tab includes a middle recess in the sliding range of the contact point portion in the axial direction and between the pair of recesses in the width direction, and
the connection region is located behind the middle recess.

3. The male terminal fitting of claim 1, wherein the pair of recesses have slopes inclined downward toward the pair of side surfaces.

4. A terminal structure, comprising a male terminal fitting and a female terminal fitting to be connected to each other, wherein:
the female terminal fitting includes a deflectable and deformable resilient piece and a contact point portion projecting on the resilient piece,
the male terminal fitting includes a solid tab extending in an axial direction,
the tab has one surface to be contacted by the contact point portion and a pair of side surfaces intersecting and connected to both ends in a width direction of the one surface,
the one surface of the tab includes a pair of recesses located on both end sides in the width direction and open in the pair of side surfaces in a sliding range of the contact point portion in the axial direction, and
a width between the pair of recesses on the one surface of the tab is smaller than a maximum width of the contact point portion.
